(19) United States
(12) Patent Application Publication
(10) Pub. No.: US 2006/0288583 A1
(43) Pub. Date: Dec. 28, 2006

(54) Method and device for using compressed gas as a weapon

(76) Inventor: Gregory Rondinone, Hamden, CT (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 11/166,729

(22) Filed: Jun. 27, 2005

(51) Int. Cl. B26B 3/00

(52) U.S. Cl. 30/123.3

(57) ABSTRACT

This device is a knife that injects compressed gas into a land or sea predator, thus disabling it instantly.

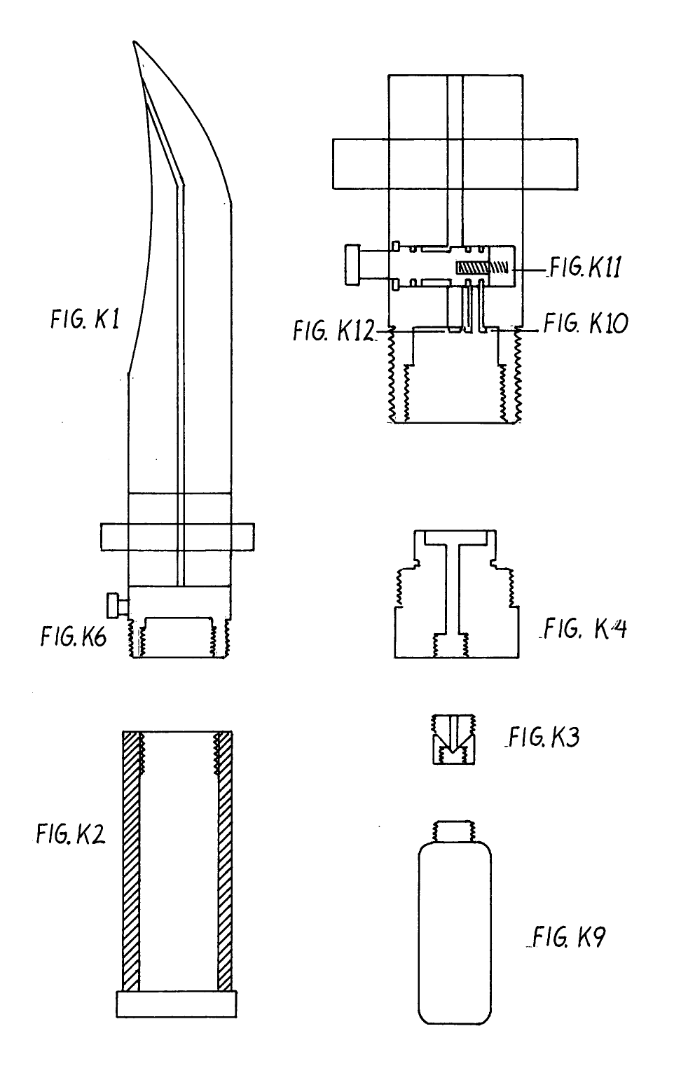

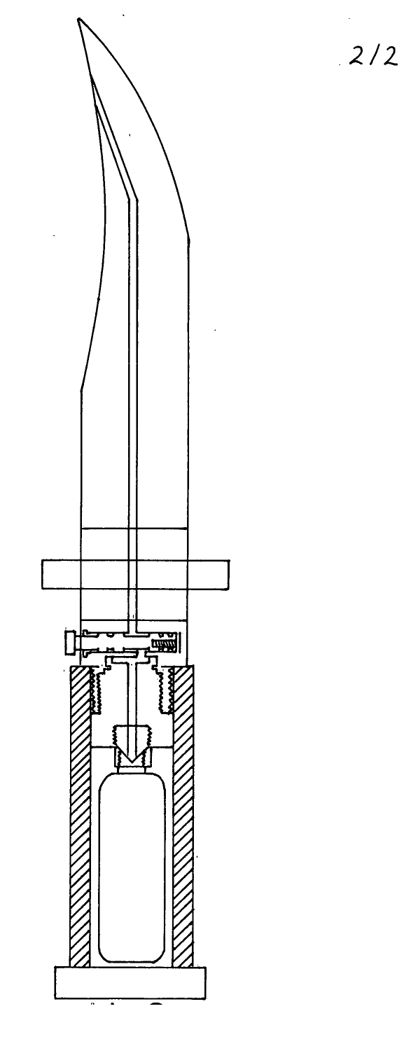

### BACKGROUND OF INVENTION

As an experienced diver, I have been fortunate to have had opportunities to explore many of the world's oceans. The undersea world is one of great mystery, beauty and history, but there are also potential dangers. The better equipped you are to handle these situations, the more rewarding an experience your dive will be.

One major concern to any diver is the possibility of an attack by an aggressive marine predator. This extremely hazardous situation is precisely why this knife was developed. As all divers know, the effects of compressed gases underwater are catastrophic. Our training teaches us that our lungs would burst from over-inflation if we held our breath with compressed gas and rose to the surface. This principal is key to the effectiveness of this invention.

### BRIEF SUMMARY OF THE INVENTION

This device uses a compressed gas cartridge (typically CO2) which is injected by a piercing device (i.e., Knife, Dart, etc.) The use of this system causes extreme damage to the organs and tissue of the target, thus disabling it instantly.

### BRIEF DESCRIPTION OF DRAWINGS

FIG. K1 Knife Blade

FIG. K2 Knife Handle

FIG. K3 Piercing Device

FIG. K4 Adapter

FIG. K10 Bushing

FIG. K11 Thumb Button

FIG. K12 Plug

### DETAILED DESCRIPTION OF INVENTION

The device is assembled by screwing an Adapter (FIG. K4) into the Knife Blade (FIG. K1). Then, you screw the Piercing Device (FIG. K3) into the Adapter (FIG. K4) before attaching the Compressed Gas Cartridge (FIG. K9) to the assembly. Once all the parts are assembled you screw the Knife Handle (FIG. K2) on to the Knife Blade (FIG. K1) and the device is armed. You now have a fully assembled knife which can be used to inject compressed gas into your target.

What I claim as my invention is:

1. The knife is a self contained unit consisting of a Knife Handle (FIG. K2), Compressed Gas Cartridge (FIG. K9), Piercing Device (FIG. K3), Adapter (FIG. K4), and Knife Blade (FIG. K1)

2. A Compressed Gas Cartridge is inserted into the knife handle and pierced by the piercing device.

3. When a target is pierced with the knife, compressed gas is released through the hole in the knife blade by pressing the thumb button (FIG. K6) and opening up a path for the air to travel.

4. Once the target is injected with the compressed gas it is instantly disabled, therefore making it no longer a threat.
